(19) United States
(12) Patent Application Publication
(10) Pub. No.: US 2004/0266530 A1
(43) Pub. Date: Dec. 30, 2004

(54) Method and system for conducting fantasy sports games on a wide area computer network

(76) Inventor: Shawn Bishop, San Diego, CA (US)

Correspondence Address: Karl M. Steins, Steins & Associates, Suite 120, 2333 Camino del Rio South, San Diego, CA, 92108, US

(21) Appl. No.: 10/608,523

(22) Filed: Jun. 27, 2003

(51) Int. Cl. G06F 19/00; G06F 17/00

(52) U.S. Cl. 463/42

(57) ABSTRACT

A Method and System for Conducting Fantasy Sports Games on a Wide Area Computer Network is disclosed. Also disclosed is a system and method that is implemented on a host computing device and delivered to client computers over a wide are computer network. The system and method improves player enjoyment by requiring players to challenge each other to fantasy sports games “duels,” with win-loss records for these duels determining fantasy team rankings. The system and method further permits current subscribers to the service to issue duel challenges to non-subscribers, such as by sending an email duel challenge. If wagering is desired, a duel challenge and acceptance would include an agreed wager amount to be awarded to the duel victor.

### BACKGROUND OF THE INVENTION

1. Field of the Invention

This invention relates generally to computerized fantasy sports games and, more specifically, to a Method and System for Conducting Fantasy Sports Games on a Wide Area Computer Network

2. Description of Related Art

Fantasy sports is a form of entertainment that involves an individual creating his or her own “fantasy” team using players that play in actual (typically professional) sports. The resultant teams are populated with a variety of players or competitors (depending upon the sport) that are not necessarily members of the same real-life team. Fantasy sports teams compete against each other by awarding points based on the individual player's performance in actual games. (or matches, races, etc.). In general, if a player does well, his or her fantasy owner receives points; the reverse is also true—poor actual performance means fewer (or no) points are earned by the player's fantasy owner. Fantasy sports can be played for virtually any organized sport or competition, including baseball, basketball, soccer, football and even automobile racing. FIG. 1 depicts how fantasy sports began.

FIG. 1 is a flowchart depicting a conventional manual fantasy sports gaming method 10. The game 10 begins by a group of typically 8 to 14 persons forming a league or division 100. One person generally identifies themselves as the “commissioner” of the league, and accepts the responsibility to calculate player points from week to week during the season.

Once the league or division is formed, each fantasy owner forms their team by conducting a division-wide player draft 102. The conventional draft 102 involves each fantasy owner, in round-robin fashion, selecting one player at a time until each fantasy owner has a complete team of starting players (and usually a few backup players to take over in the event of injuries). In this prior manual method 10, each player can only be selected by a single fantasy owner; there may or may not be some fantasy cap on the fantasy salary that can be used for player drafting by each team, but otherwise the formation rules are fairly simple.

Each week, as the actual events occur, the commissioner calculates the points that each player earns for his or her fantasy owner. Depending upon the design of the league, there are two general competitive scenarios for fantasy team owners. Under the first scenario, the fantasy owners compete with all other owners in their division/league each week 104 in batch fashion. In this environment, “batch” fashion means that all owners compete against all other owners each week of the season.

In the batch. scenario, at the end of the regular season for the sport, the fantasy owner with the most overall points is declared the winner of their league 106. There may be intermediate winners during the season also; these also would be selected as the fantasy team having the most points in a particular time period (as compared to all other team owners).

The second scenario is known as “head-to-head.” Head-to-head became prevalent in manual American football fantasy leagues; in this format, a fixed schedule is developed 105. This schedule pairs up teams against one another once or twice each during the regular season (i.e. not in the postseason/playoffs/championships). Each team knows its schedule for the entire season before the beginning of the season, with no option of changing it.

Under the prior head-to-head system, the fantasy teams having the best record of wins go to the “playoffs.” The playoffs are a single elimination bracket that result in a single champion after points are won in head-to-head contests with the other advancing teams. There is no concept related to certain teams having elevated performance classifications based on the win-loss record of their opponents (i.e. there is no strength of schedule factor) in determining the playoff participants or the ultimate champion of the league.

It has been observed that in recent years, the fantasy sports market has experienced explosive growth in the United States. Due mostly to the World-wide Web, fantasy sports have grown from a fan hobby into a legitimate industry that generates in excess of $100 million in revenue annually. Furthermore, according a national poll, thirty million Americans engage in fantasy sports every year.

Most fantasy sports related web sites are reporting extremely high growth rates, especially those that offer fantasy products, such as league management software, fantasy contests and interactive games. One major provider's database of registered users grew to approximately 10 million users in 2002, an increase of 4 million users, or sixty percent, from the previous year! FIG. 2 depicts one of these prior methods.

FIG. 2 is a flowchart depicting a prior Wide-area Network-based fantasy sports gaming method 12 of Gavriloff, U.S. Pat. No. 6,371,855. The Gavriloff method 12 begins, generally, by a person establishing a user account 108, which typically will involve the payment of some service charge to the service-provider in order to participate in the gaming.

Unlike the manual system, in the Gavriloff player draft, one real-world player can be put on an unlimited number of different teams. In order to maintain some competitiveness between fantasy teams, there is a limit to the total team value that each fantasy owner can spend on players. Player value is based on fantasy owner supply/demand calculations (e.g. the more popular the player, the more points, and therefore value, that player will be “worth”).

Competition in the Gavriloff system, just like the prior manual method, is on an all-team, batch basis, where the winner at the end of the season (and at intermediate points throughout the season) is selected based on the best overall score, expressed as the highest “team value.”

There are two major problems with both the manual fantasy gaming method and the prior world wide web-based methods: (1) none of these methods adequately encourage or allow play between current users/account holders and non-account holders/users—you must first join the group prior to being able to participate; and (2) all of the competitions are of the batch type, meaning that once your team is set, your only activity throughout the season is to change the personnel composition of the team—since you essentially play every other fantasy owner every game, there is a low limit on the amount of strategy that an owner can engage in.

While there have been some rudimentary attempts at “head-to-head” competitions between fantasy teams, these do not add much strategy to the game over the conventional batch method, since the schedules are pre-set and require all owners to play all other owners in some sort of rotation. Because there is no control of their schedule, there is no strategic activity possible by the fantasy owners in this regard.

What is needed, therefore, is a wide-area network-based fantasy sports method and system that enables current fantasy owners to entice non-owners into their game in order to increase the upside growth potential for the system. The system should further include the ability for fantasy owners to have more strategic control of their schedule in order to further enhance the fantasy sports experience.

### SUMMARY OF THE INVENTION

In light of the aforementioned problems associated with the prior methods and systems, it is an object of the present invention to provide a Method and System for Conducting Fantasy Sports Games on a Wide Area Computer Network. The system should be implemented on a host computing device and delivered to client computers over a wide are computer network. The system should improve player enjoyment by requiring players to challenge each other to fantasy sports games “duels,” with win-loss records for these duels determining fantasy team rankings. The system should further permit current subscribers to the service to issue duel challenges to non-subscribers, such as by sending an email duel challenge. If wagering is desired, a duel challenge and acceptance should include an agreed wager amount to be awarded to the duel victor.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a flowchart depicting a conventional manual fantasy sports gaming method;

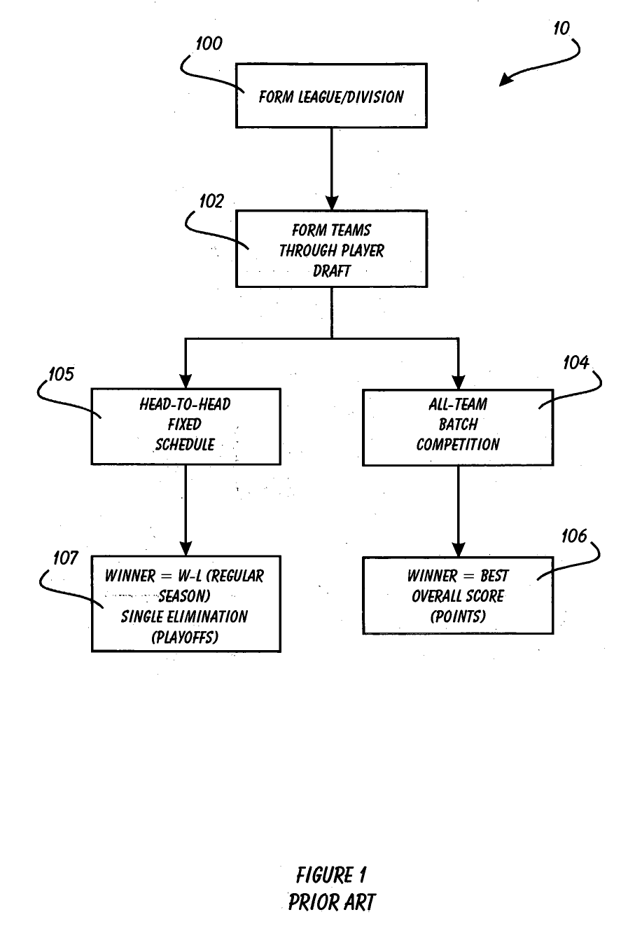

FIG. 2 is a flowchart depicting a prior Wide-area Network-based fantasy sports gaming method;

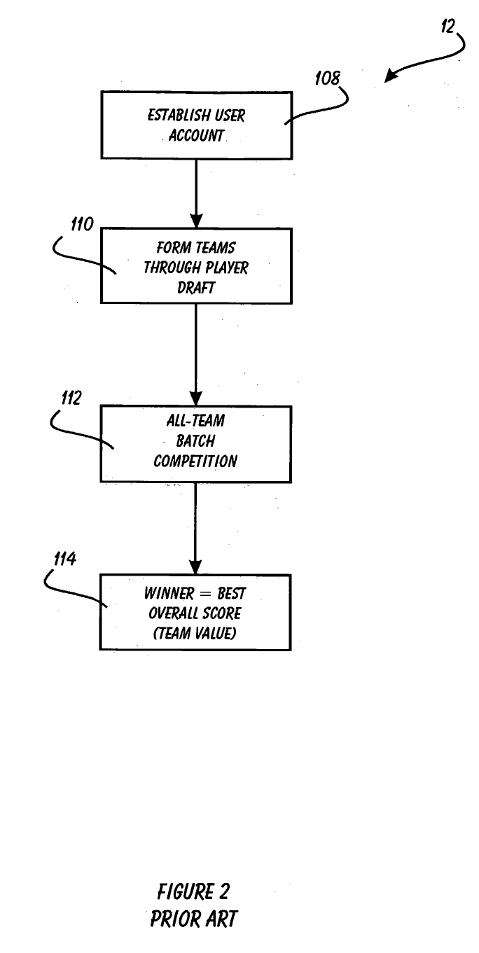

FIG. 3 is a flowchart depicting a preferred embodiment of the fantasy sports duel gaming method of the present invention;

FIG. 4 is a block diagram showing the functional arrangement of the components of the system of FIG. 3;

FIG. 5 is a flowchart depicting the intranetwork duel challenge method of the present invention;

FIG. 6 is a, flowchart depicting the extranetwork duel challenge method of the present invention; and

FIG. 7 is a table depicting the features comparisons between the prior methods and systems with that of the present invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Method and System for Conducting Fantasy Sports Games on a Wide Area Computer Network.

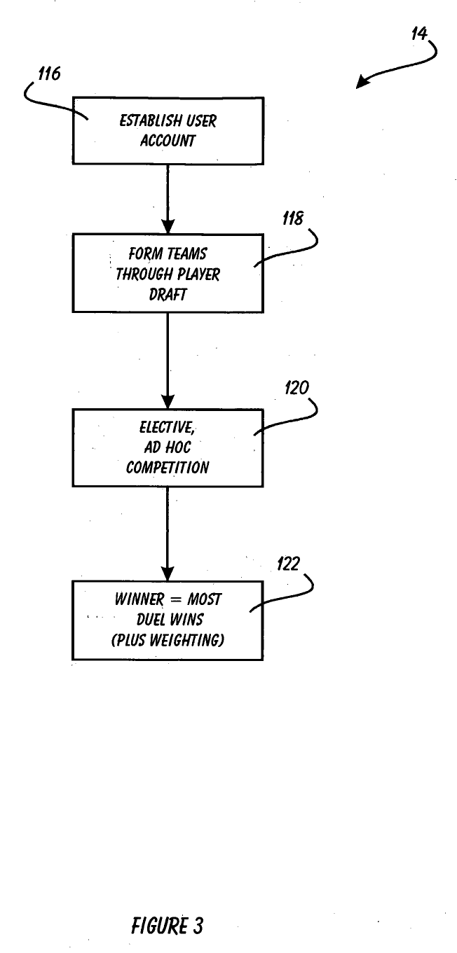

The present invention can best be understood by initial consideration of FIG. 3. FIG. 3 is a flowchart depicting a preferred embodiment of the fantasy sports duel gaming method 14 of the present invention. In this method 14, after establishing a user account 116, the user forms one or more teams through a player draft 118. As with Gavriloff, there is no limit on the number of fantasy teams that a real-world player can play on.

What is truly unique about this method 14 and related system is that the competition between teams is elective by the fantasy owners, and occurs on an ad hoc basis. As will be discussed more fully below in connection with other drawing figures, under this method 14, fantasy owners decide for themselves when their fantasy team(s) will play as well as which other fantasy teams their team(s) will play against.

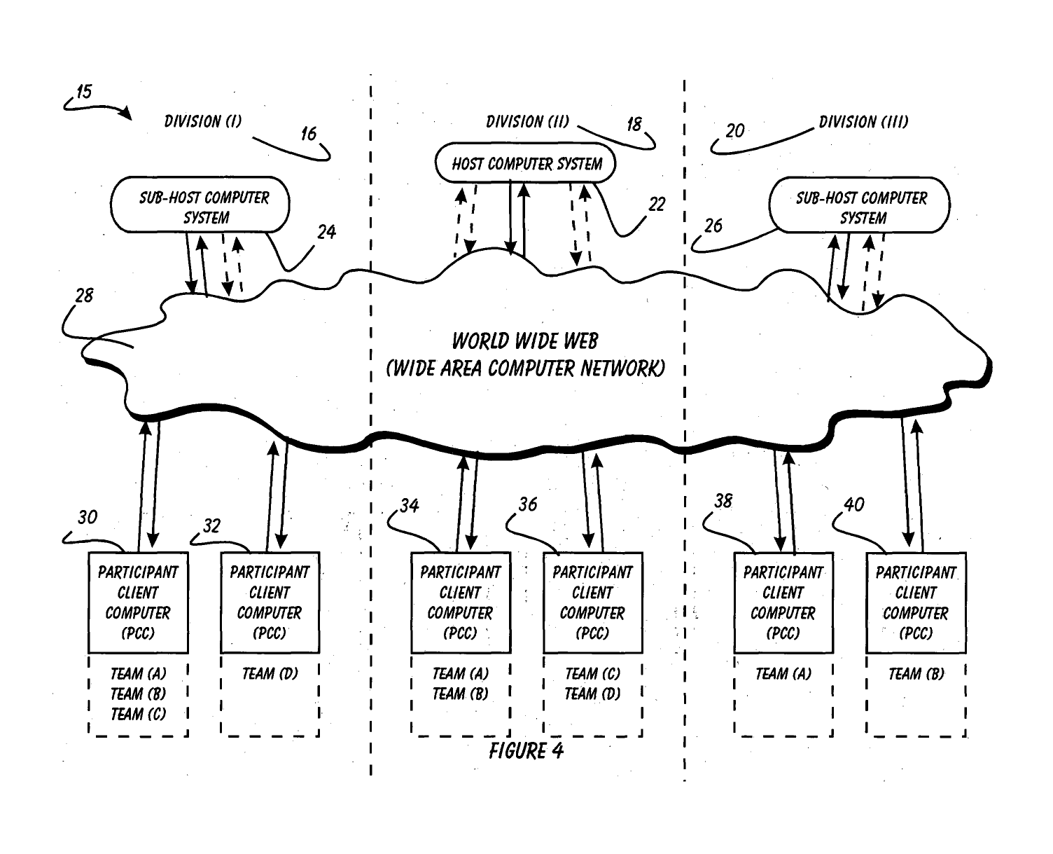

Unlike the prior methods and systems, under the present method 14, the winner is determined by the most duel wins during the regular season whichever fantasy teams have the most one-on-one wins against other fantasy teams at the and of the season are the season victors (and, depending upon the sport, may go on to the playoffs). Furthermore, certain wins against certain teams can be “worth” more than other wins—this is a “strength of schedule” weighting factor that simply doesn't exist in other fantasy sports methods and systems. If we now turn to FIG. 4, we can examine the hardware in the gaming system.

FIG. 4 is a block diagram showing the functional arrangement of the components of the system 15 that executes the method of FIG. 3. The system 15 may be made up of numerous “divisions” of fantasy owners; here, three divisions (I-III), 16-20, respectively are the subject of our study. There can be one or more divisions in which the gaming system is being executed and managed by a host computer system 22. There may be one or more other divisions (e.g. 16 and 20) that are hosted by outside or “subhost” computer systems 24 and 26. The sub-host computers 24 and 26 provide gaming services directly to their respective constituencies, but the data and functionality is actually drawn from the host computer 22 over the world wide web 28 (or other wide area computer network).

Each division provided by a sub-host computer system 24 or 26 has the same functionality and services that the division(s) provided by the host computer system 22, however their look and feel may be customized for a particular divisional partner's needs and wants for their target subscribership.

As discussed above, the system 15 is expected to be most desirable as a wide area network based system, such as the world wide web (e.g. the Internet ™), however, the system and method is entirely suitable for local area networks, either alone or in a network of networks. One substantial benefit of the approach taken by the present system 15 is that participant client computers (PCC), i.e. user/subscribers to the gaming system of the present invention, whether subscribers to the host computer system 22 or one of the sub-host computer systems (e.g. 24 and 26), have full ability to play fantasy games against all other user/subscribers—there are no boundaries.

In the example shown here, PCC 30 is a fantasy owner that established Teams (A), (B) and (C) in Division I; PCC 32 has created only a single team, Team (D) in Division I. Likewise, the fantasy owner at PCC 34 has created Teams (A) and (B) in Division II, and the owner at PCC 36 has created Teams (C) and (D). Finally (in this brief example), owner at PCC 38 has created single Team (A) and at PCC 40, single Team (B) have been created in Division III (hosted by sub-host computer system 24).

Any of the previously-listed teams can engage in duel play against any other team in the system 15, once both teams agree to the duel. As such, Team (A) in Division I could play Team (A) in Division III, even though neither fantasy owner has subscribed to their gaming service through the main Host Computer System 22.

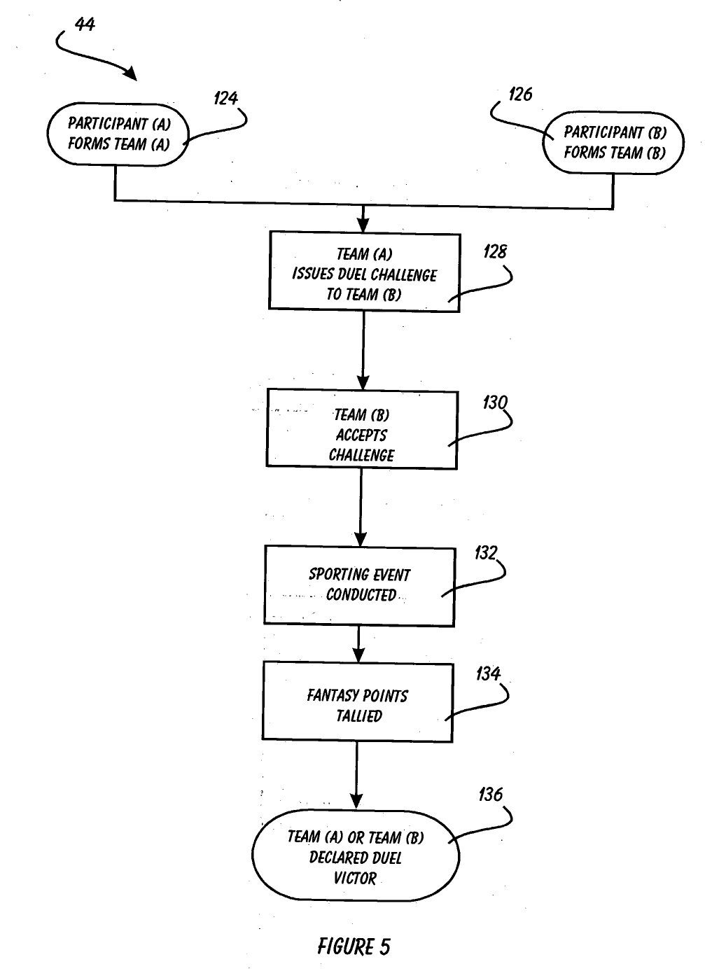

The important byproduct or side benefit of this essentially unlimited dueling activity is that as the season progresses, there is ongoing encouragement for new teams to be created. Since an owner could theoretically challenge every other team for every actual game, it is very possible that the fantasy competition would not become closed to new teams until the end of the season, since the new owners would have ample opportunities to rack up enough wins to make the playoffs. This is in stark contrast to the prior games, wherein if a team misses a single game, it is at a decided disadvantage because it cannot make up a game, even in environments where pre-scheduled head-to-head games are used. Now we'll turn to FIG. 5 to examine how the dueling function operates under this new system.

FIG. 5 is a flowchart depicting the intranetwork duel challenge method 44 of the present invention. The term “intranetwork” in this context means between registered subscribers to the duel challenge gaming system described herein; examples would be any of the Division I through Division III teams shown in the example of FIG. 4.

The method shown here is simply one example of how a duel challenge operates; the identifications of the pertinent parties are generic and are provided simply to assist in the understanding of the method.

The method 44 commences with Participant (A) (i.e. a fantasy owner/subscriber to the system) forms Team (A) 124. Participant (B) forms Team (B) 126 at some point either before or after Team (A) is formed, but in any case both teams are formed prior to the challenge being issued. Next, Team (A) issues a duel challenge to Team (B) 128 via the gaming method being executed on the host computer system. The duel challenge contains the following information: the team challenging, the team being challenged, and the event date for the challenge (this could be a single day, or a week of competition, etc.). The challenge notification may take the form of an instant message from one participant to the other, it may be an electronic mail (email) from one participant to another, or it could even be sent via wireless means, such as to a Personal Digital Assistant, pager or cellular telephone.

If Team (B) chooses to accept the duel challenge 130, then this duel challenge is set, and cannot be canceled. Alternatively, Team (B) might decline to accept the challenge, or still further, Team (B) may choose to make a counter-challenge to Team (A), such as challenging for a different day/week. The counter-challenge is especially desirable for NFL-based fantasy sports, where some real-world teams do not play on some weeks (“bye weeks”); if a fantasy team is challenged to play on a weekend where one or more extremely important players have bye weeks, that challenged team would not want to play—an alternate week, however, might be acceptable.

Once the duel is set, the two fantasy teams have some limitation on their ability to change fantasy team rosters—it would not be desirable to allow teams to change their personnel once they've accepted a challenge from another fantasy team. In the time between setting the duel (i.e challenge 128 and acceptance 130 has occurred), and the time of the conduct of the actual sporting event 132 (the “warmup period”), the dueling teams cannot use any new players that were added to their rosters after the duel is set or scheduled. Any players that are sold or traded by the teams in the warmup period will not be eligible to play for their team unless the fantasy owner/subscriber re-acquires the player prior to the actual sporting event.

Once the actual sporting event is conducted 132, the actual players will establish actual performance statistics (during the event); these will equate to their fantasy scores, based upon their individual (and in some cases team or portions of teams) performances. These can be called “unvested” player points, meaning they only count (or become “vested”) for those fantasy teams that actually have a duel for that day/week/weekend. Since, in our example here, Teams (A) and (B) have a duel on the date of this sporting event 132, their players' points are vested, and therefore tallied and attributed to their respective fantasy teams 134.

Between Team (A) and Team (B), the duel victor is declared 136 solely depending upon the Teams' respective vested point totals for this one duel. No other events or duels are considered, either with other teams or with each other at other times. This duel challenge format adds substantial control and enjoyment to the fantasy owners—now, their teams only play when and whom they choose.

It is expected that as teams accrue fantasy wins (or a certain winning percentage), they will climb a hierarchical ladder of proficiency classifications (e.g. rookie, intermediate, semi-pro, professional). During this climb and through the playoffs between the most proficient teams, it is expected that wins will be weighted based on the number of wins or percentage against the, more proficient teams. Only those with the requisite number or percentage of wins against proficient teams (i.e. semi-pro or professional classifications) will be eligible for the fantasy playoffs and ultimately the championship(s).

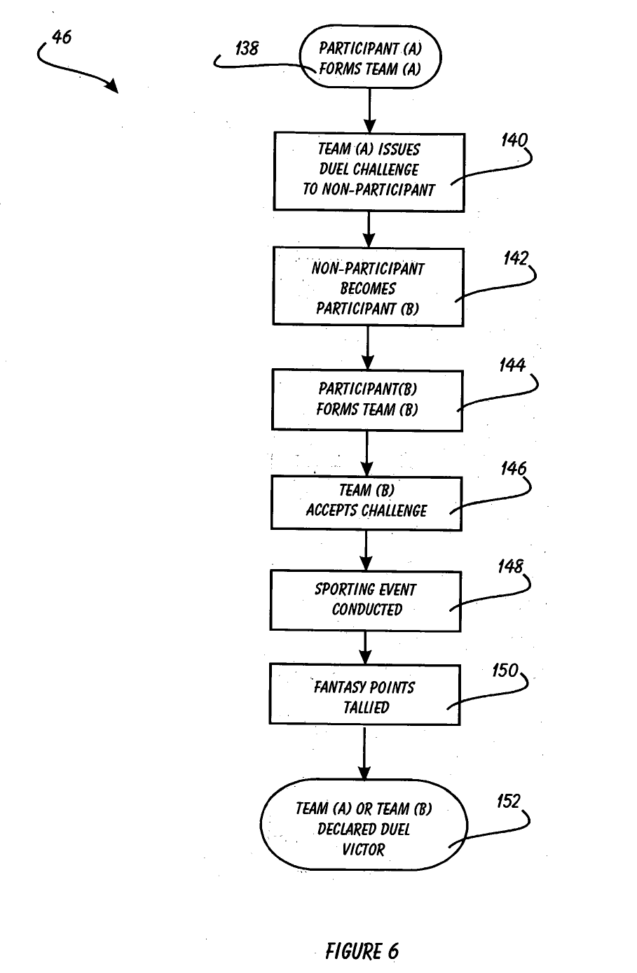

Once in the playoffs, the competition will be batch in nature, however, the best teams (i.e. those in the highest proficiency classification) will receive “bye's” (i.e. automatic advancement) through at least the first round of playoff games. This hierarchical ladder of proficiency classifications encourages fantasy owners to continue to challenge the winningest teams, since wins against these opponents are worth more. Turning to FIG. 6, we can take a look at another novel aspect of the present system and method.

FIG. 6 is a flowchart depicting the extranetwork duel challenge method 46 of the present invention. Here, the term “extranetwork” refers to a challenge issued from a current fantasy owner/subscriber (i.e. to the system of the present invention) to an individual who is not currently signed up with the service (and therefore does not yet have any teams or even any identity within the environment of the system of the present invention.

Participant (A) first must have a team prior to issuing a challenge; Team (A) is formed 138. Next, Team (A) issues a duel challenge to a non-participant 140. The extranetwork duel challenge can be in virtually any form available for intranetwork challenges, the only difference being that Participant (A) must provide the contact information/method to be used; in the intranetwork challenge scenario, the gaming system will already have this information.

Upon receipt of the challenge, for example by email, the non-participant can choose to refrain from accepting (or even responding at all), or he or she can become a participant of the gaming system (Participant (B)) 142. Next, Participant (B) must form his or her own team (Team (B)) 144, and then accept the challenge 146 (of course the challenge can be refused or countered, as discussed above in connection with FIG. 6). Again, the actual sporting event is conducted 148, and the fantasy points are tallied 150 and the vested points are attributed to their respective teams (between Team (A) and Team (B)).

It must be pointed out that each team owner must identify a starting lineup of players. The fantasy owner, has a team roster that is made up of a starting lineup and reserve players; if a starting player is injured, traded (i.e. the real live player), then one of the reserve players will take his place. Finally, as between Team (A) and Team (B) for this particular duel, and their particular starting lineups, a victor is declared.

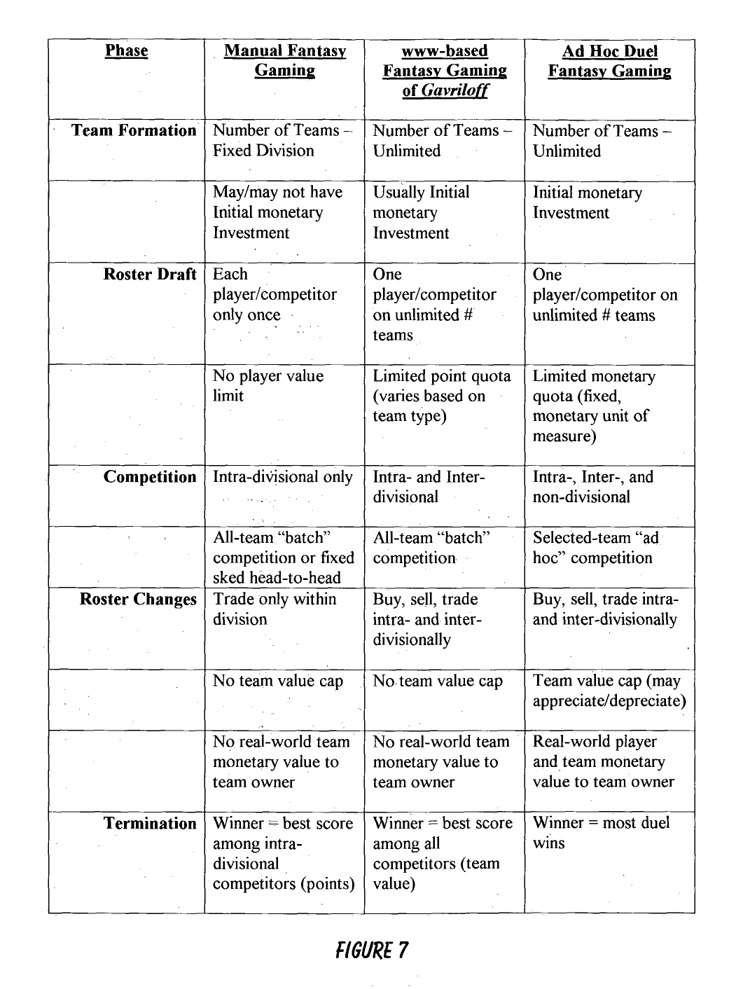

The novel ability to make these extranetwork duel challenges provides growth potential in the gaming system that previously was unavailable. The combination of the dueling format allowing for late-season commencement of play for some fantasy owners, with the ability to entice one's friends into playing within the gaming system provides incentive and capability that is simply unavailable under the prior fantasy games. In order to highlight the distinctions between the prior art and the present invention in more detail, FIG. 7 has been provided.

FIG. 7 is a table comparing the features of the prior methods and systems to that of the present invention. At team formation, the ad hoc duel (challenge) fantasy gaming system of the present invention permits an unlimited number of teams, and in fact encourages team formation well into the actual sports season.

Regarding the roster draft, in its initial form, the duel fantasy gaming system will require an initial monetary investment; in fact, it is expected that this amount will actual constitute the initial “salary cap” for the team to be drafted (if more teams are desired, a larger deposit will be necessary). The players' valuation will be initially based on their popularity within the gaming system (and not their performance statistics), and then normalized so that the fantasy owners can assemble a competitive team while staying within their salary cap.

Since the player values are normalized to be equivalent to an actual monetary unit of measure (e.g. dollars), the fantasy owners can earn (and lose) real money by player sales and purchases. The actual monetary equivalence normalization, then, adds yet another competitive incentive to the fantasy gaming system of the present invention over the prior art.

As for the competition, here are two critical distinctions between the present invention and the prior art—(1) non-subscriber (i.e. extranetwork) challenges are possible using the present system; and (2) only selected teams can get wins or losses from their elective ad hoc duel competitions.

Roster changes are permitted (within the limitations discussed above related to the warmup period) in the fantasy gaming system of the present invention, but trades, sales and purchases of players after a team's initial draft will be on a supply and demand basis. In other words, a player cannot be sold without there being a prior purchase order, a player cannot be bought unless another fantasy owner wishes to sell the same player and the price is agreeable. It is possible that a particular team will exceed their salary cap simply due to the popularity increase (and therefore value increase) of their fantasy player(s) and team. In these cases, additional buying power will be created; if the converse occurs, however (i.e. the team value reduces beneath the original salary cap), the fantasy owner is prohibited from adding additional funding to their account for player purchase. Any income from these transaction becomes real monetary value on account for the owner/subscriber's use at his or her discretion.

When the term duel challenge is used herein, it is intended to convey at least two types of challenges: (1) a non-wager duel challenge; and (2) a wager duel challenge. The only significant difference between these two types of challenges is that when one participant makes a wager duel challenge to another participant (or non-subscriber), there will be a wager amount in currency contained within the challenge that the challenge issuer wishes to be the victor's prize for that duel.

Those skilled in the art will appreciate that various adaptations and modifications of the just-described preferred embodiment can be configured without departing from the scope and spirit of the invention. Therefore, it is to be understood that, within the scope of the appended claims the invention may be practiced other than as specifically described herein.

What is claimed is:

1. In a network of computing devices comprising two or more participant client computers in communication with a host computer system over a computer network, a fantasy gaming method executed by said host computer system for interaction therewith at said participant client computers, the method comprising the steps of:
a first participant creating a first team via one said participant client computer;
a second participant creating a second team via one said participant client computer;
a challenge to engage in a fantasy game issued by said first team to said second team; and
an acceptance of said challenge by said second team.

2. The method of claim 1, wherein said challenge step comprises said first team challenging said second team to engage in a fantasy game at a future date.

3. The method of claim 1, wherein:
said acceptance step is preceded by said second team issuing a counterchallenge to said first team, and
said acceptance step is an acceptance of said counterchallenge by said first team.

4. The method of claim 1, wherein:
said challenge and said acceptance create a first duel, wherein as between said first and second teams, a victor of said first duel is determined by performance results of actual players in an actual sporting event.

5. The method of claim 4 wherein said method further comprises:
a third participant creating a third team via one said participant client computer;
said third team engaging in a second duel with either said first team or said second team.

6. The method of claim 5, wherein said method defines a regular season that is defined by a plurality of said teams engaging in a plurality of said duels to determine win-loss records for each said team responsive to victors and non-victors of said duels.

7. The method of claim 6, wherein said method further defines performance classification groups of said teams, said performance classification group classifications responsive to the strength of duel schedule of said respective teams.

8. A system for providing an interactive fantasy sports game to a plurality of participants each participant wishing to form at least one fantasy sports team made up of actual players, and each participant operating a participant computing device operable to act as a client on a communications network, the system comprising:
a host controller, the host controller comprising a computing device operable to act as a server on said communications network and to communicate with said participant computing device over said communications network, and
data storage accessible to said host controller, the data storage storing information relating to performance of the players in actual competitive events, the host controller being operable:
to solicit and accept from each participant an initial selection and purchase of players to form the participants fantasy sports team, and
responsive to a request from one participant and an acceptance from another participant, to schedule a duel challenge between said participants' respective fantasy sports team.

9. The system of claim 8, wherein said host controller is further operable to:
select a winner and a loser of said duel challenge responsive to points earned by said players on said participants' respective fantasy sports teams engaging in said actual competitive events.

10. The system of claim 9, wherein said host controller is further operable to:
record winners and losers of a plurality of said duel challenges between a plurality of said particpants' fantasy sports teams; and
assign a hierarchical performance classification to each said fantasy sports team based on the number of duel challenges won and lost by each said fantasy sports team.

11. The system of claim 10, wherein said host controller is further operable:
to create a playoff schedule between teams having the highest said performance classification.

12. The system of claim 8, wherein said host controller is further operable to accept a request from one participant for a duel challenge with a non-participant.

13. The system of claim 12, wherein said host controller is further operable to accept an acceptance to said duel challenge from said non-participant after said non-participant becomes a participant.

14. A method of providing a network-based, ad hoc duel fantasy gaming system, the method being implemented in a programmed computer comprising a processor, at least one data storage system, and communication means for communication with participant client computers over a communications network, the method comprising the steps of:
a first team creation via one said participant client computer;
a challenge to engage in a fantasy game issued by said first team to a non-subscriber;
a second team creation via one said participant client computer by said non-subscriber; and
an acceptance of said challenge by said second team.

15. The method of claim 14, wherein said challenge step comprises said first team challenging said non-subscriber to engage in a fantasy game at a future date.

16. The method of claim 15, wherein:
said acceptance step is preceded by said second team issuing a counterchallenge to said first team; and
said acceptance step is an acceptance of said counterchallenge by said first team.

17. The method of claim 16, wherein:
said challenge and said acceptance create a first duel, wherein as between said first and second teams, the winner of said first duel and the loser of said first duel are determined by performance results of actual players in an actual sporting event.

18. The method of claim 17 wherein said method further comprises:
a third participant creating a third team via one said participant client computer;
said third team engaging in a second duel with either said first team or said second team.

19. The method of claim 18, wherein said method defines a regular season that is defined by a plurality of said teams engaging in a plurality of said duels to determine win-loss records for each said team responsive to winners and losers of said duels.

20. The method of claim 14, wherein said challenge step and said acceptance step further comprises a wager.
